(19) United States
(12) Patent Application Publication
(10) Pub. No.: US 2013/0332639 A1
(43) Pub. Date: Dec. 12, 2013

(54) ELECTRONIC APPARATUSES AND RELATED CONTROLLING METHODS USING THE SAME

(71) Applicant: ACER INCORPORATED, New Taipei City (TW)

(72) Inventors: Shu-Yu JIANG, New Taipei City (TW); Yung-Sen LIN, New Taipei City (TW)

(73) Assignee: ACER INCORPORATED, New Taipei City (TW)

(21) Appl. No.: 13/846,059

(22) Filed: Mar. 18, 2013

(30) Foreign Application Priority Data
Jun. 6, 2012 (TW) 101120219

(51) Int. Cl. G06F 13/40

(52) U.S. Cl. CPC G06F 13/4022
USPC 710/300

(57) ABSTRACT

Controlling methods for use in a module of an electronic apparatus are provided. The module can support at least a high-speed expansion bus interface and a low-speed expansion bus interface and is coupled to a platform controller hub (PCH) through the high-speed expansion bus interface and the low-speed expansion bus interface. First, one of the high-speed expansion bus interface and the low-speed expansion bus interface is assigned for data transmission with the PCH. Then, a detection result corresponding to the electronic apparatus or the module is obtained and the other one of the expansion bus interfaces is to be switched to for data transmission with the PCH according to the detection result.

### CROSS REFERENCE TO RELATED APPLICATIONS

This Application claims priority of Taiwan Application No. 101120219, filed on Jun. 6. 2012, the entirety of which is incorporated by reference herein.

### BACKGROUND OF THE INVENTION

1. Field of the Invention

The disclosure relates generally to electronic apparatuses and controlling methods using the same and, more particularly, to electronic apparatuses and controlling methods using the same capable of dynamically switching among multiple expansion buses for data transmission.

2. Description of the Related Art

Recently, with the vigorous development of computer sciences and technologies, electronic apparatuses such as computer systems and portable devices, e.g. laptop computers, tablet computers, smart phones and so on, may be equipped with multiple input/output modules as well as functional modules, such as keyboards, mouse, hard disks, network interface cards and other types of interface cards and so on. Each individual module may able to perform the data transmission operation with a processing unit (such as the CPU) Through a Platform Controller Hub (also referred to as PCH). The PCH provides multiple expansion bus interfaces for the input/output modules and the functional modules that are compatible with different specifications or standards to perform the data transmission with the processing unit. Each module may simultaneously support one or more than one expansion bus interface. When a module supports only one type of expansion bus interface, the module may use that expansion bus interface to perform the transmitting and receiving of data. Assuming that the module may able to support multiple expansion bus interfaces, a single module can use only one of the supported expansion bus interfaces to perform the transmitting and receiving of data. For example, if a module is a network card that simultaneously supports a PCI Express (abbr. PCIe) and SDIO bus interfaces, the network card will be connected directly to the PCIe bus interface and performs the data transmission through the PCIe bus interface since the PCIe bus has a higher data transmission capability. Once a specific expansion bus interface has been chosen for data transmission, the module may not able to switch to another bus interface to perform the data transmission.

### BRIEF SUMMARY OF THE INVENTION

Electronic apparatuses and controlling methods using the same capable of dynamically switching among multiple expansion buses for data transmission are provided.

In an embodiment, a controlling method for use in a module of an electronic apparatus is provided. The module supports at least a high-speed expansion bus interface and a low-speed expansion bus interface and is coupled to a platform controller hub (PCH) through the high-speed expansion bus interface and the low-speed expansion bus interface. The method comprising the following steps. First, one of the high-speed expansion bus interface and the low-speed expansion bus interface is assigned to perform a data transmission operation with the PCH. Thereafter, a detection result associated with the electronic apparatus or the module is obtained and the other one of the high-speed expansion bus interface and the low-speed expansion bus interface is switched to perform the data transmission operation with the PCH according to the detection result.

Another embodiment of an electronic apparatus at least comprises a processing unit, a platform controller hub (PCH) and at least one module. The PCH is coupled to the processing unit and arranged for providing at least a high-speed expansion bus interface and a low-speed expansion bus interface. The module is coupled to the PCH and has a first interface control unit and a second interface control unit, wherein the first and second interface control units are coupled to the high-speed expansion bus interface and the low-speed expansion bus interface respectively. Any of the high-speed expansion bus interface and the low-speed expansion bus interface can be switched to/activated to perform a data transmission operation with the PCH.

Controlling methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electronic apparatus of the invention;

FIG. 2 is a flowchart of an embodiment of a controlling method of the invention;

FIG. 3 is a flowchart of another embodiment of a controlling method of the invention for illustrating how to switch between the high-speed expansion bus interface and the low-speed expansion bus interface; and

FIG. 4 is a flowchart of yet another embodiment of a controlling method of the invention for illustrating how to switch between the high-speed expansion bus interface and the low-speed expansion bus interface.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide expansion bus interface control methods for modules that simultaneously supports more than two types of different speed expansion bus interfaces, and can switch dynamically among the supported different speed expansion bus interfaces based on the different statuses/states of the system or modules for choosing either performance or power saving as the primary consideration, thereby enhancing the performance of the system.

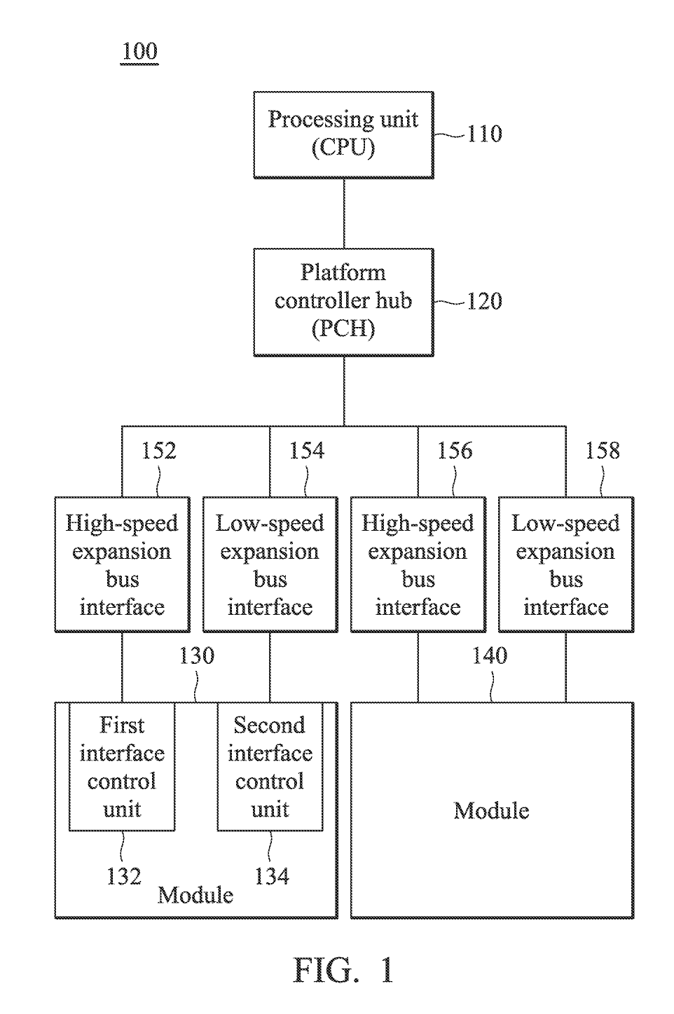

FIG. 1 is a schematic diagram illustrating an embodiment of an electronic apparatus of the invention. The electronic apparatus 100 may include computer systems, such as personal computers, handheld devices and portable devices, e.g. laptop computers, PDAs (personal digital assistant), tablet computers, smart phones or any other type of similar devices. However, it is to be understood that the invention is not limited thereto. As shown in FIG. 1, the electronic apparatus 100 at least comprises a processing unit 110, a platform controller hub (PCH) 120 and multiple modules 130 and 140, wherein the PCH 120 is coupled to the processing unit 110 and the modules 130 and 140 are coupled to the PCH 120. For example, the modules 130 and 140 may be any wired or wireless communication modules, such as blue-tooth communication modules, WiFi or 3G communication modules or WLAN communication modules in compliance with IEEE 802.1X standard, for connecting to responsive wired or wireless AP 200 to connect to a network via the connected AP such that the electronic apparatus 100 may access resources on the connected network, but the invention is not limited thereto. The network may comprise, for example, wired or wireless networks, such as the Internet, WiFi or 3G wireless networks, but the invention is not limited thereto.

The PCH 120 provides multiple expansion bus interfaces to connect to the modules 130, 140 with different functions. For example, the expansion bus interfaces may comprises a PCI express (PCIe) expansion bus interface, a SDIO expansion bus interface, a USB expansion bus interface, a UART expansion bus interface and so on, but it is not limited thereto. Each of the modules 130, 140 may support as least two different speed expansion bus interfaces, such as a high-speed expansion bus interface and a low-speed expansion bus interface, such that the modules 130, 140 can be connected to the PCH 120 simultaneously through these two different speed expansion bus interfaces and perform a data transmission operation with the PCH 120 through these two different speed expansion bus interfaces. For example, as shown in FIG. 1, the module 130 is connected to the PCH 120 through the high-speed expansion bus interface 152 and the low-speed expansion bus interface 154, whereas the module 140 is connected to the PCH 120 through the high-speed expansion bus interface 156 and the low-speed expansion bus interface 158, but the invention is not limited thereto.

For example, if the module 130 is a wireless communication module; the high-speed expansion bus interface can be the PCIe expansion bus interface while the low-speed expansion bus interface can be the SDIO expansion bus interface. Therefore, the module 130 can choose to perform a high-speed data transmission operation with the PCH 120 through the high-speed expansion bus interface or perform a low-speed data transmission operation with the PCH 120 through the low-speed expansion bus interface. Note that the high-speed expansion bus interface typically allows high-speed data transmission, but on the other hand it is more power consuming, whereas the low-speed expansion bus interface allows low-speed data transmission and is also more power saving. Therefore, different speed expansion bus interfaces are suitable for different requirements.

The module 130 is coupled to the PCH 120 and has at least a first interface control unit 132 and a second interface control unit 134, wherein the first interface control unit 132 and the second interface control unit 134 are coupled to the high-speed expansion bus interface 152 and the low-speed expansion bus interface 154 respectively. In one embodiment, the high-speed expansion bus interface 152 may comprise expansion bus interfaces compatible with the PCI Express and/or USB expansion bus interface standard and the low-speed expansion bus interface 154 may comprise expansion bus interfaces compatible with the SDIO and/or UART expansion bus interface standard, and the first interface control unit 132 may provide expansion bus interface bus signals that are compatible to the PCI Express and/or USB expansion bus interface standard for coupling to the high-speed expansion bus interface, while the second interface control unit 134 may provide expansion bus interface bus signals that are compatible to SDIO and/or UART expansion bus interface standard for coupling to the high-speed expansion bus interface. The modules 130 and 140 can perform the controlling method of the present invention for dynamically selecting either the connected high-speed expansion bus interface or low-speed expansion bus interface, or correspondingly switch from the high-speed expansion bus interface to the low-speed expansion bus interface, or switch from the low-speed expansion bus interface to the high-speed expansion bus interface, to perform the data transmission operation with the PCH 120 based on the system or module states/statuses, such as the power source states, task status, data throughput and so on. The responsive controlling method will be discussed further in the following paragraphs.

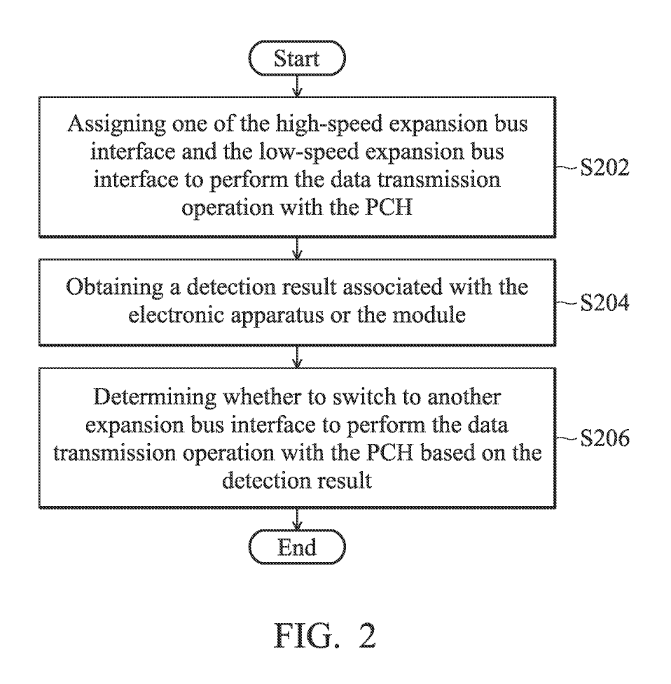

FIG. 2 is a flowchart of an embodiment of a controlling method of the invention. Please refer to FIGS. 1 and 2. The controlling method can be applied to the module 130 of the electronic apparatus 100 for dynamically switching a transmission interface for data transmission between the module 130 and the PCH 120. In this embodiment, it is assumed that the module 130 supports at least a high-speed expansion bus interface 152 and a low-speed expansion bus interface 154, wherein the module 130 is connected to the PCH 120 through the high-speed expansion bus interface 152 and the low-speed expansion bus interface 154.

First, in step S202, the module 130 assigns one of the high-speed expansion bus interface 152 and the low-speed expansion bus interface 154 to perform the data transmission operation with the PCH 120. Because the module 130 is connected to the PCH 120 through the high-speed expansion bus interface 152 and the low-speed expansion bus interface 154, therefore, either the high-speed expansion bus interface 152 or the low-speed expansion bus interface 154 may be used to perform the data transmission operation with the PCH 120. The module 130 may have a predefined data transmission interface, and at the initial the module 130 can use the assigned predefined data transmission interface to perform the data transmission operation with the PCH 120. For example, the module 130 may assign the connected high-speed expansion bus interface 152 as the predefined data transmission expansion bus interface and thus utilize the high-speed expansion bus interface 152 to perform the data transmission operation with the PCH 120.

After the module 130 has performed the data transmission operation with the PCH 120 through the assigned expansion bus interface, in step S204, the module 130 then obtains a detection results associated with the electronic apparatus 100 or the module 130. To be more specific, the electronic apparatus 100 may provide a detection result associated with the electronic apparatus 100 or the module 130 and the module 130 may obtain the detection result associated with the electronic apparatus 100 or the module 130 by using its driver, firmware or other hardware circuits. In some embodiments, the module 130 may obtain the detection result associated with the electronic apparatus 100 or the module 130 by using its driver or using firmware or other hardware circuits of the electronic apparatus 100 such as a BIOS, an embedded controller, the PCH 120 and so on. In another embodiment, the module 130 may obtain the detection results associated with specific detection items of the electronic apparatus 100 or the module 130 via the PCH 120 and from the operating system executed by the processing unit 110. In this case, the detection results associated with the electronic apparatus 100 or the module 130 may include detection result regarding a power state of the electronic apparatus 100 (such as whether it is in a power-saving mode), a power source of the electronic apparatus 100 (such as whether it is an external power), a power state of the module 130, the data throughput required between the module 130 and the PCH 120, and types of applications activated and so on. For example, the module 130 may obtain the detection result associated with the electronic apparatus 100 or the module 130 directly or obtain it indirectly through the PCH 120.

After obtaining the detection result associated with the electronic apparatus 100 or the module 130, in step S206, the module 130 determines whether to switch to another expansion bus interface to perform the data transmission operation with the PCH 120 based on the detection result obtained. In one embodiment, the step that the module 130 determines whether to switch to another expansion bus interface based on the detection result obtained may further comprise the steps of performing the operation of either switching from the high-speed expansion bus interface to the low-speed expansion bus interface or switching from the low-speed expansion bus interface to the high-speed expansion bus interface. For example, assuming the above-mentioned detection includes detecting the power source of the system, and based on the detected power source, the module 130 determines that it is an external power source (such as an AC adaptor) and as there is no power saving consideration, the module 130 may choose the high-speed expansion bus interface 152, which has a high-speed data transmission capability to act as the transmission interface or perform a switch from the low-speed expansion bus interface 154 to the high-speed expansion bus interface 152 to use the high-speed expansion bus interface for performing the data transmission. It is understood that, if the high-speed expansion bus interface 152 has already been used as the transmission interface at this time, the module 130 does not need to perform any expansion bus interface switch.

In other words, the module 130 can determine whether to make the consideration based primarily on performance or power saving according to the different statuses/states of the electronic apparatus 100 or the module 130 so as to automatically switch the expansion bus interface with the PCH 120 for performing the data transmission operations, thus further enhancing the performance of the system.

In some embodiments, the module 130 may select/switch to the high-speed expansion bus interface 152 or the low-speed expansion bus interface 154 by enabling or disabling the first interface control unit 132 or the second interface control unit 134. When the first interface control unit 132 is enabled, the module 130 may perform the data transmission operation with the PCH 120 through the high-speed expansion bus interface 152. On the contrary, when the first interface control unit 132 is disabled, the module 130 will not be able to perform the data transmission operation with the PCH 120 through the high-speed expansion bus interface 152. Similarly, when the second interface control unit 134 is enabled, the module 130 may perform the data transmission operation with the PCH 120 through the low-speed expansion bus interface 154. On the contrary, when the second interface control unit 134 is disabled, the module 130 will not be able to perform the data transmission operation with the PCH 120 through the low-speed expansion bus interface 154. Therefore, when the module 130 wishes to perform the operation of switching from the high-speed expansion bus interface 152 to the low-speed expansion bus interface 154, the module 130 may perform this operation it through disabling the first interface control unit 132 and enabling the second interface control unit 134. Similarly, the module 130 may perform the operation of switching from the low-speed expansion bus interface 154 to the high-speed expansion bus interface 152 through disabling the second interface control unit 134 and enabling the first interface control unit 132.

For explanation, various detection and controlling methods are illustrated as examples in the following embodiment, and those skilled in the art will understand that the present invention is not limited thereto. In the following embodiments, it is assumed that the electronic apparatus 100 can be a portable device, such as a laptop computer or a smart phone and the module 130 can be a wireless module, which can establish a connection with a wireless network and supports a high-speed expansion bus interface (e.g. the PCIe bus interface) and a low-speed expansion bus interface (e.g. the SDIO bus interface). For example, the module can be a WLAN communication module that can establish a connection with a wireless LAN, but it is not limited thereto.

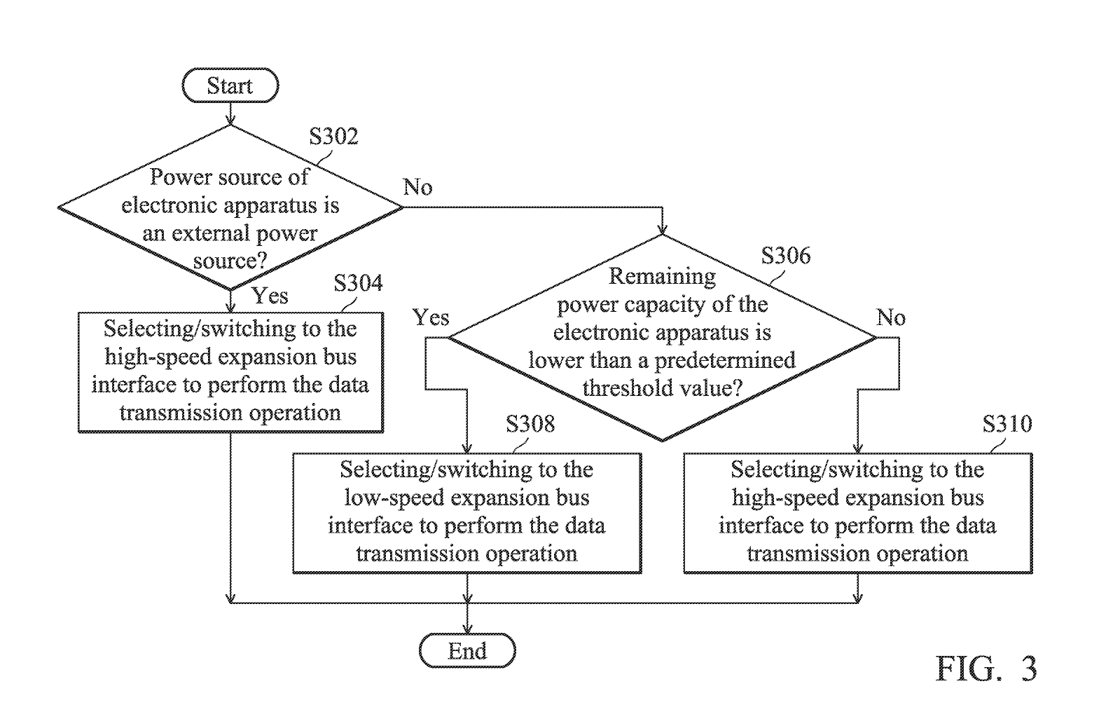

In some embodiments, the detection result may be obtained by detecting a power source of the electronic apparatus 100 and the module 130 may self-determine whether to select the high-speed or low-speed expansion bus interface to act as the transmission expansion bus interface based on the type of power source detected. FIG. 3 is a flowchart of another embodiment of a controlling method of the invention for illustrating how to switch between the high speed expansion bus expansion bus interface and the low speed expansion bus expansion bus interface. Please refer to FIGS. 1 and 3. The controlling method can be applied to the module 130 of the electronic apparatus 100. In this embodiment, it is assumed that the detection result is obtained by detecting a power source of the electronic apparatus 100.

In S302, the module 130 determines whether the power source of electronic apparatus 100 is an external power source based on the detection results. In this case, the module 130 may obtain the power source information of the electronic apparatus 100 from the processing unit 110 through the PCH 120. The power source may include external power resource such as an externally connected AC adaptor or non-external power sources such as batteries and so on.

When the detected power source for the electronic apparatus 100 is an external power source (Yes in step S302), in step S304, the module 130 determines to switch to the high-speed expansion bus interface to perform the data transmission operation. Contrarily, when the detected power source for the electronic apparatus 100 is not an external power source (No in step S302), e.g. the power source is from a battery, in step S306, the module 130 then detects a remaining power capacity of the electronic apparatus 100 and determines whether it is lower than a predetermined threshold value to determine whether to switch to the high-speed expansion bus interface or the low-speed expansion bus interface to perform the data transmission. When detecting that the remaining power capacity of the electronic apparatus 100 is lower than the predetermined threshold value (Yes in step S306), in step S308, the module 130 determines to switch to the low-speed expansion bus interface to perform the data transmission operation. When detecting that the remaining power capacity of the electronic apparatus 100 is higher than or equal to the predetermined threshold value, in step S310, the module 130 determines to switch to the high-speed expansion bus interface to perform the data transmission operation.

For example, it is assumed that the electronic apparatus 100 is a portable device and the module 130 is a wireless module such as a WLAN module. The wireless module may detect whether or not the power source of the electronic apparatus 100 is an external power source to determine whether to select the high-speed or low-speed expansion bus interface to act as the transmission interface. When detecting that the power source of the electronic apparatus 100 is an external power source (such as an AC adaptor), the wireless module selects the high-speed expansion bus interface (i.e. the PCIe bus interface) to act as the transmission, when it is not an external power source, for example the power source is from a battery or a limited power source, the wireless module may further detect the remaining power capacity of the electronic apparatus 100 and when the detected remaining power capacity of the electronic apparatus 100 is below 50%, the wireless module selects the low-speed expansion bus interface (i.e. the SDIO bus interface) to act as the transmission interface. When the detected remaining power strength of the electronic apparatus 100 is not below 50%, that is, the remaining power capacity of the battery is more than 50%, the wireless module selects/switches to the high-speed expansion bus interface (i.e. the PCIe bus interface) to act as the transmission interface.

In some embodiments, the detection result may be obtained by detecting a power state of the electronic apparatus and the module 130 may self-determine whether to select the high-speed or low-speed expansion bus interface to act as the transmission expansion bus interface based on the type of power state detected. For the purpose of power management, typically, devices have five types of Advanced Configuration and Power interface (ACPI) state, for example: S0, S1, S3, S4 and S5 states, wherein among these five types of state, only S0 state is a normal operating state of a computer system, whereas S1, S3, S4 and S5 states occur when the computer system is in sleep or hibernation. In addition, ACPI also defines other types of power state, such as device power states, processor power states and other power states in order to facilitate the understanding of the entire power usage of the device. For example, the device power states of ACPI can be classified into D0-D3 states, wherein D0 state is a fully on state and it is also the state that has the highest power consumption among all the device power states, while D3 state is an off state and it is also the state with the highest power saving among all the device power states. Detail description of all type of power states defined in the ACPI and responsive meaning and operations are well-known in the art and thus are omitted here for brevity. Note that the different states of ACPI are utilized to determine whether to perform the switch between the high-speed and the low-speed expansion bus interfaces in the following embodiments.

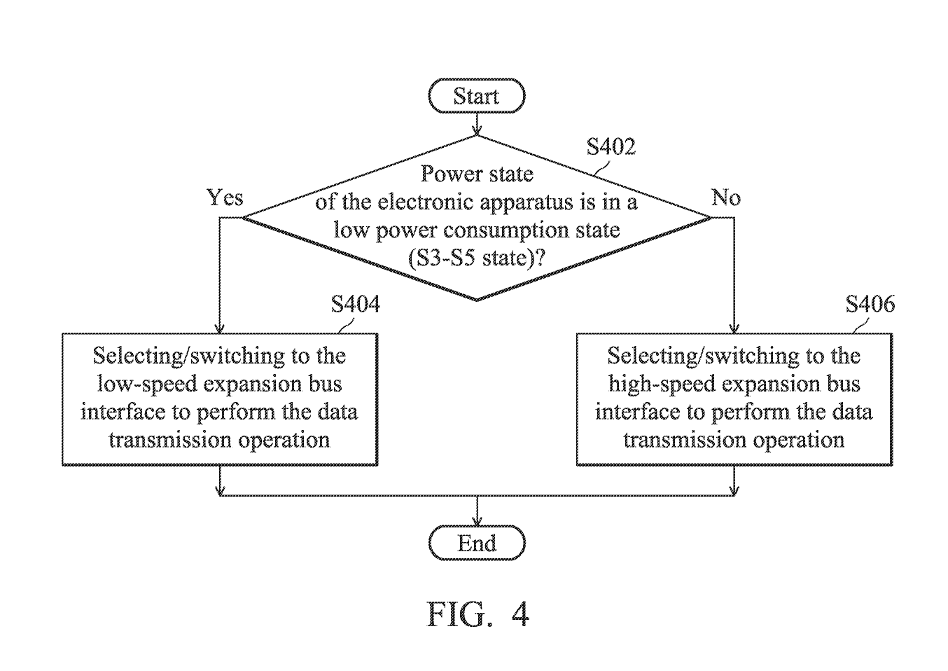

FIG. 4 is a flowchart of yet another embodiment of a controlling method of the invention for illustrating how to switch between the high speed expansion bus expansion bus interface and the low speed expansion bus expansion bus interface. Please refer to FIGS. 1 and 4. The controlling method can be applied to the module 130 of the electronic apparatus 100. In this embodiment, it is assumed that the detection result is obtained by detecting a power state of the electronic apparatus 100.

In S402, the module 130 determines whether the power state of the electronic apparatus 100 is in a low power consumption state based on the detection results. In this case, the electronic apparatus 100 may provide the detection result containing power state information regarding the power state of the electronic apparatus 100 and module 130 may directly obtain the power state information of the electronic apparatus 100 from the processing unit 110 directly. In this embodiment, it is assumed that the electronic apparatus 100 is determined as in a low power consumption state when its power state is in any of the S3, S4 or S5 state. When detecting that the detected power state of the electronic apparatus 100 is in a low power consumption state (Yes in step S402), i.e., the power state is in any of the S3, S4 or S5 state, in step S404, the module 130 determines to select/switch to the low-speed expansion bus interface to perform the data transmission operation. Contrarily, when detecting that the power state of the electronic apparatus 100 is not in the low power consumption state (No in step S402), e.g. when the power state is the SO state, in step S406, the module 130 determines to select/switch to the high-speed expansion bus interface to perform the data transmission operation.

For example, as above-mentioned, it is assumed that the electronic apparatus 100 is a portable device and the module 130 is a wireless module such as a WLAN module and supports a high-speed expansion bus interface (e.g. the PCIe bus interface) and a low-speed expansion bus interface (e.g. the SDIO bus interface). When detecting that the power state of the electronic apparatus 100 is in a low power consumption state (e.g. the power state is any of the S3, S4 or S5 state or other predefined power-saving state), the wireless module selects/switches to the low-speed expansion bus interface (i.e. the SDIO bus interface) to act as the transmission interface. When detecting that the power state of the electronic apparatus 100 is not in the low power consumption state (e.g. the power state is the SO state), the wireless module selects/switches to the high-speed expansion bus interface (i.e. the PCIe bus interface) to act as the transmission interface.

In another embodiment, the detection result may be obtained by detecting a power state of the module 130 and the module 130 may self-determine whether to select the high-speed or low-speed expansion bus interface to act as the transmission expansion bus interface based on the type of power state detected. For example, the power states of the wireless module can first be pre-defined as high-performance state and low-performance state respectively. When detecting that the power state of the wireless module is in a high-performance state (e.g. the power state of the wireless module is in the DO state defined in ACPI), the wireless module selects/switches to the high-speed expansion bus interface (i.e. the PCIe bus interface) to act as the transmission interface for data transmission. Contrarily, when detecting that the power state of the wireless module is in a power state other than the high-performance states (e.g. the power state of the wireless module is in the D3 state defined in ACPI), the wireless module selects/switches to the low-speed expansion bus interface (i.e. the SDIO bus interface) to act as the transmission interface for data transmission.

In yet another embodiment, the wireless module can be connected to a network and the detection result may be obtained by detecting a connection status of the wireless module and the network. The electronic apparatus 100 may establish a connection link with an Access Point (AP) through the module 130 to connect to the network and access data from the network. For example, if the network is the Internet and the module 130 is a WLAN communication module that is compatible with the IEEE802.11a standard, the electronic apparatus 100 may establish a connection link with the AP in the wireless network and perform wireless communication through the WLAN communication module 130, and then connect to the Internet at its back-end via the AP. To be more specific, the wireless module is able to detect the connection status between itself and an AP to determine whether to select the high-speed or the low-speed expansion bus interface to act as the transmission interface. Similarly, the aforementioned connection status can be pre-defined as high-traffic states and low-traffic states respectively. When detecting that the connection status for the wireless module is in a high-traffic state, the wireless module selects/switches to the high-speed expansion bus interface (i.e. the PCIe bus interface) to act as the transmission interface for data transmission. Contrarily, when detecting that the connection status for the wireless module is in a low-performance state (e.g. any of the connected standby, the association idle or the non-association idle state), the wireless module selects/switches to the low-speed expansion bus interface (i.e. the SDIO bus interface) to act as the transmission interface for data transmission.

In some embodiments, the detection result may be obtained by detecting a data throughput required between the module 130 and the PCH 120 and the module 130 may self-determine whether to select the high-speed or low-speed expansion bus interface to act as the transmission expansion bus interface based on the size of the detected data throughput. In one embodiment, the module 130 may detect a data throughput transmitted between the module 130 and the PCH 120 to obtain the data throughput required therebetween and then determines whether it is a high data throughput to determine whether to select the high-speed or low-speed expansion bus interface to act as the transmission interface for data transmission. When detecting that the data throughput required between the module 130 and the PCH 120 is a high data throughput (e.g. the data throughput is higher than or equal to a predetermined threshold value), the module 130 selects/switches to the high-speed expansion bus interface (i.e. the PCIe bus interface) to act as the transmission interface for data transmission. Contrarily, when detecting that the data throughput required between the module 130 and the PCH 120 is a low data throughput (e.g. the data throughput is lower the predetermined threshold value), the module 130 selects/switches to the low-speed expansion bus interface (i.e. the SDIO bus interface) to act as the transmission interface for data transmission.

In some embodiments, the detection result may be obtained by detecting whether a predetermined high speed application has been activated and the module 130 may self-determine whether to select the high-speed or low-speed expansion bus interface to act as the transmission interface based on a determination result of whether a predetermined high speed application has been activated or deactivated. When detecting that the predetermined high speed application has been activated, the module 130 selects/switches to the high-speed expansion bus interface (i.e. the PCIe bus interface) to act as the transmission interface for data transmission. Contrarily, when detecting that the predetermined high speed application has not been activated, the module 130 selects/switches to the low-speed expansion bus interface (i.e. the SDIO bus interface) to act as the transmission interface for data transmission. For example, the wireless module may automatically determine whether to select the high-speed or low-speed expansion bus interface to act as the transmission interface based on a determination result of whether any application with wireless display functionality has been activated or deactivated. When detecting that an application with wireless display functionality has been activated, the wireless module selects/switches to the high-speed expansion bus interface (i.e. the PCIe bus interface) to act as the transmission interface for data transmission. Contrarily, when detecting that none of the applications with wireless display functionality has been activated, the module 130 selects/switches to the low-speed expansion bus interface (i.e. the SDIO bus interface) to act as the transmission interface for data transmission.

Note that the various parameters mentioned above, such as the low power consumption states, the high performance states, the predetermined high-speed applications, the predetermined threshold values or the likes, are provided for illustration, but are not limited thereto. In some embodiments, depending on the actual consideration that whether it is for the power saving or for enhancing performance, those parameters may all be adjusted and different modules may apply same or different parameters to achieve the required performance. Additionally, multiple modules may share the same bus expansion bus interface or apply the controlling methods of the invention to switch between the various shared expansion bus interfaces to perform the data transmission operation.

In sum, with the electronic apparatuses and related controlling methods of the invention, modules simultaneously supporting two or more different speeds expansion bus interfaces can switch dynamically among its supported expansion bus interfaces based on the detection results from the different status/states of the system or modules and can select the appropriate expansion bus interface corresponding to the individual detection result for data transmission, thus providing better performance or higher power saving.

Controlling methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A controlling method for use in a module of an electronic apparatus, wherein the module supports at least a high-speed expansion bus interface and a low-speed expansion bus interface and is coupled to a platform controller hub (PCH) through the high-speed expansion bus interface and the low-speed expansion bus interface, the method comprising:
assigning one of the high-speed expansion bus interface and the low-speed expansion bus interface to perform a data transmission operation with the PCH;
obtaining a detection result associated with the electronic apparatus or the module; and
switching to the other one of the high-speed expansion bus interface and the low-speed expansion bus interface to perform the data transmission operation with the PCH according to the detection result.

2. The controlling method of claim 1, wherein the switching step further comprises switching from the high-speed expansion bus interface to the low-speed expansion bus interface or switching from the low-speed expansion bus interface to the high-speed expansion bus interface according to the detection result.

3. The controlling method of claim 1, wherein the detection result is obtained by detecting a power source of the electronic apparatus and the switching step further comprises:
when detecting that the power source of the electronic apparatus is an external power source, switching to the high-speed expansion bus interface to perform the data transmission operation with the PCH; and
when detecting that the power source of the electronic apparatus is not the external power source, detecting a remaining power capacity of the power of the electronic apparatus to determine whether to switch to the high-speed expansion bus interface or the low-speed expansion bus interface to perform the data transmission operation with the PCH.

4. The controlling method of claim 3, wherein the step of detecting the remaining power capacity of the power of the electronic apparatus to determine whether to switch to the high-speed expansion bus interface or the low-speed expansion bus interface further comprises:
when detecting that the remaining power capacity of the electronic apparatus is lower than a predetermined threshold value, switching to the low-speed expansion bus interface to perform the data transmission operation; and
when detecting that the remaining power capacity of the electronic apparatus is higher than or equal to the predetermined threshold value, switching to the high-speed expansion bus interface to perform the data transmission operation.

5. The controlling method of claim 1, wherein the detection result is obtained by detecting a power state of the electronic apparatus and the switching step further comprises:
when detecting that the power state of the electronic apparatus is in a low power consumption state, switching to the low-speed expansion bus interface to perform the data transmission operation; and
when detecting that the power state of the electronic apparatus is not in the low power consumption state, switching to the high-speed expansion bus interface to perform the data transmission operation.

6. The controlling method of claim 1, wherein the detection result is obtained by detecting a power state of the module and the switching step further comprises:
when detecting that the power state of the module is in a high performance state, switching to the high-speed expansion bus interface to perform the data transmission operation; and
when detecting that the power state of the module is not in the high performance state, switching to the low-speed expansion bus interface to perform the data transmission.

7. The controlling method of claim 1, wherein the detection result is obtained by detecting a data throughput required between the module and the PCH, and the switching step further comprises:
when detecting that the data throughput is lower than a predetermined threshold value, switching to the low-speed expansion bus interface to perform the data transmission operation; and
when detecting that the data throughput is higher than or equal to a predetermined threshold value, switching to the high-speed expansion bus interface to perform the data transmission operation.

8. The controlling method of claim 1, wherein the detection result is obtained by detecting whether a predetermined high speed application has been activated, and the switching step further comprises:
when detecting that the predetermined high speed application has been activated, switching to the high-speed expansion bus interface to perform the data transmission operation; and
when detecting that the predetermined high speed application has not been activated, switching to the low-speed expansion bus interface to perform the data transmission operation.

9. The controlling method of claim 1, wherein the module is a communication module connected to a network, and the detection result is obtained by detecting a connection status of the communication module and the network.

10. An electronic apparatus, comprising:
a processing unit;
a platform controller hub (PCH) coupled to the processing unit, providing at least a high-speed expansion bus interface and a low-speed expansion bus interface; and
at least one module coupled to the PCH, having a first interface control unit and a second interface control unit, wherein the first and second interface control units are coupled to the high-speed expansion bus interface and the low-speed expansion bus interface respectively,
wherein any of the high-speed expansion bus interface and the low-speed expansion bus interface can be switched/activated to perform a data transmission operation with the PCH.

11. The electronic apparatus of claim 10, wherein the electronic apparatus further provides a detection result which is obtained by detecting a power source of the electronic apparatus such that the electronic apparatus switches to/activates the high-speed expansion bus interface or the low-speed expansion bus interface to perform the data transmission operation with the PCH according to the detection result.

12. The electronic apparatus of claim 11, wherein the module further switches to the high-speed expansion bus interface to perform the data transmission operation when the power source of the electronic apparatus is an external power source, and the module further detects a remaining power capacity of the power of the electronic apparatus to determine whether to switch to the high-speed expansion bus interface or the low-speed expansion bus interface to perform the data transmission operation when the power source of the electronic apparatus is not the external power source.

13. The electronic apparatus of claim 12, wherein the module further switches to the low-speed expansion bus interface to perform the data transmission operation when detecting that the remaining power capacity of the electronic apparatus is lower than a predetermined threshold value and switches to the high-speed expansion bus interface to perform the data transmission operation when detecting that the remaining power capacity of the electronic apparatus is higher than or equal to the predetermined threshold value.

14. The electronic apparatus of claim 10, wherein the detection result is obtained by detecting a power state of the electronic apparatus and the module further switches to the low-speed expansion bus interface to perform the data transmission operation when detecting that the power state of the electronic apparatus is in a low power consumption state and switches to the high-speed expansion bus interface to perform the data transmission operation when detecting that the power state of the electronic apparatus is not in the low power consumption state.

15. The electronic apparatus of claim 10, wherein the detection result is obtained by detecting a power state of the module, and the module further switches to the high-speed expansion bus interface to perform the data transmission operation when detecting that the power state of the module is in a high performance state and switches to the low-speed expansion bus interface to perform the data transmission when detecting that the power state of the module is not in the high performance state.

16. The electronic apparatus of claim 10, wherein the detection result is obtained by detecting a data throughput required between the module and the PCH, and the module further switches to the low-speed expansion bus interface to perform the data transmission operation when detecting that the data throughput is lower than a predetermined threshold value and switches to the high-speed expansion bus interface to perform the data transmission operation when detecting that the data throughput is higher than or equal to a predetermined threshold value.

17. The electronic apparatus of claim 10, wherein the module further selects/switches to the high-speed expansion bus interface or the low-speed expansion bus interface by enabling or disabling the first interface control unit or the second interface control unit.

18. The electronic apparatus of claim 10, wherein the high-speed expansion bus interface comprises expansion bus interfaces compatible with PCI Express and/or USB interface standard and the low-speed expansion bus interface comprises expansion bus interfaces compatible with SDIO and/or UART interface standard.

19. The electronic apparatus of claim 10, wherein the electronic apparatus is a portable device.
